(19) United States
(12) Patent Application Publication
(10) Pub. No.: US 2026/0165529 A1
(43) Pub. Date: Jun. 18, 2026

(54) NON-COATED NON-STICK COOKWARE AND MANUFACTURING METHOD THEREOF

(71) Applicant: Tibet Suntrue Houseware Tech Co., Ltd., Lhasa, Tibet (CN)

(72) Inventors: Xuelu DONG, Lhasa (CN); Xucai TU, Lhasa (CN)

(21) Appl. No.: 18/711,095

(22) PCT Filed: Aug. 23, 2023
(86) PCT No.: PCT/CN2023/114432

§ 371 Date: May 16, 2024

(30) Foreign Application Priority Data
Nov. 30, 2022 (CN) 2022115278550

(51) Int. Cl. A47J 36/02; C25D 11/02; C25D 11/16; C25D 11/18; C25D 11/26; C25D 11/30

(52) U.S. Cl. CPC A47J 36/025; C25D 11/026; C25D 11/16; C25D 11/18; C25D 11/26; C25D 11/30

(57) ABSTRACT

The present disclosure discloses a non-coated non-stick cookware and a manufacturing method thereof, which relate to the technical field of cooking utensils. The non-coated non-stick cookware includes a cookware body. A plurality of anti-sticking holes are distributed on an inner surface of the cookware body, an inner wall and/or a bottom wall of the anti-sticking hole is provided with a micro-arc oxide layer which has a plurality of nano-scale micropores, and edges of some or all of the micropores are of mastoid-shaped. The present disclosure achieves non-coated physical non-stick performance by physical means without chemical coating.

### TECHNICAL FIELD

The present disclosure relates to the technical field of cooking utensils, and particularly to a non-coated non-stick cookware and a manufacturing method thereof.

### BACKGROUND

For non-stick cookware with PTFE Teflon coating currently sold in the market, the highest withstand temperature of the PTFE Teflon coating is not greater than 250° C., and a temperature of greater than 250° C. will lead to rapid reduction in non-stick performance of the PTFE Teflon coating and rapid carbonization and shedding thereof. Thus, the coating has the problems such as short service life, poor dry-burning resistance and easy shedding, which cause a lot of waste of metal materials to the country every year. The existing honeycomb cookware sold in the market realizes non-stick function by being sprayed with a non-stick paint after etching, which also has the problems of poor dry-burning resistance, easy shedding and the like. Even if not being damaged, the paint will be slowly worn by food and finally all eaten by people along with the food, which not only affects the service life of the product, but also harms the health of the human body.

### SUMMARY

In order to solve the above problems, the present disclosure provides a novel non-coated non-stick cookware, which achieves the non-stick performance by physical means without chemical coating layer.

In order to achieve the above objective, the present disclosure adopts the following technical solutions:
A non-coated non-stick cookware, including a cookware body. A plurality of anti-sticking holes are distributed on an inner surface of the cookware body, an inner wall and/or a bottom wall of the anti-sticking hole is provided with a hard oxide layer which has nano-scale micropores, and edges of all of the micropores are of mastoid-shaped.

Optionally, the hard oxide layer has a thickness of 10 μm to 50 μm. The non-stick cookware with honeycomb coating in the prior art has the characteristic that the honeycomb holes are large with an aperture more than 3 mm, so the bottom surfaces of the honeycomb holes are also coated with coating that has a large area of about 80% to 90% of the surface area of the base material. As a result, the contact area between the coating and food is also large, which leads to a large friction surface with food, such that the coating is easily worn and has a short service life. Compared with the non-stick cookware with honeycomb coating in the prior art, the technical solution provided by the present disclosure equally divides the inner surface of the cookware into numerous micro-planes based on the principle of calculus to form various anti-sticking holes, forms a hard oxide layer with high hardness and nano-scale pores in the anti-sticking holes, and forms mastoid-shaped structures from the edges of some or all of the micro-pores, so that the mastoid-shaped structures achieve a fluff-like effect. Meanwhile, these nano-sized pores will absorb air and grease during actual use, and generate hot air and oil mist during heating, while holding up food. By means of the fluff-like effect achieved by the mastoid-shaped structures, the friction between food and the inner surface of the cookware body is reduced, and the non-stick effect is achieved by physical means without chemical coating, so that consumers can cook food more healthily. In the present disclosure, if the plate forming the cookware body is made of titanium, a hard oxide layer of titanium dioxide with Vickers hardness not lower than HV600 will be generated on the surface of the plate on which the micro-arc oxidation has been carried out; and if the plate forming the cookware body is made of aluminum alloy, a hard oxide layer of aluminum oxide with Vickers hardness not lower than HV1000 will be generated on the surface of the plate on which the micro-arc oxidation has been carried out. The Vickers hardness of the hard oxide layer generated from other materials should not be lower than HV500. The generated hard oxide layer with high hardness makes the inner surface of the cookware body resistant to a metal spatula. In addition, since the oxide in the anti-sticking hole has the characteristics of dry-burning resistance and high-temperature resistance, it can withstand a high temperature of 1000° C. without reduction in performance, so there is no need to worry about dry burning of the cookware, and the service life of the cookware is greatly improved.

Optionally, the anti-sticking hole is a circle and/or a polygon, and when the anti-sticking hole is a circle, an aperture thereof is a diameter of the circle; and when the anti-sticking hole is a polygon, an outer diameter thereof is a diameter of a circumscribed circle of the polygon.

Optionally, the anti-sticking hole has an aperture of 0.5 mm to 3 mm and a depth of 50 μm to 200 μm.

Optionally, the anti-sticking hole is formed by etching or punching a plate which constitutes the cookware body.

By controlling the aperture of the anti-sticking hole between 0.5 mm to 3 mm, and the depth thereof between 50 μm to 200 μm, the effects of high density and small diameter can be achieved, which not only ensures that the hard oxide layer can achieve the fluff-like effect after being formed in the anti-sticking hole, but also reduces the contact area between food and the base material of the inner surface of the cookware body.

Optionally, the cookware body is made of aluminum, titanium or magnesium; or the cookware body is made of a composite material, and the inner surface of the cookware body is made of aluminum, magnesium or titanium.

Meanwhile, the present disclosure further provides a manufacturing method of a non-coated non-stick cookware, including the steps of: etching or punching a plate to form anti-sticking holes on a surface of the plate, and molding the plate having the anti-sticking holes formed by etching or punching into a cookware body, where the surface that is punched or etched is an inner surface of the cookware body; carrying out micro-arc oxidation on the inner surface of the cookware body, to form a hard oxide layer with nano-scale micropores, where edges of some or all of the micropores are of mastoid-shaped; sanding and polishing the inner surface of the cookware body to remove the hard oxide layer on the inner surface, with the hard oxide layer in the micro-pores being retained, as illustrated in FIG. 3; and sanding and polishing an outer surface of the cookware.

Optionally, the micro-arc oxidation is carried out with a current per square decimeter of 1 A to 3 A, a voltage per square decimeter of 300 V to 550 V, a duty ratio of 3% to 10%, and an oxidation time of 25 to 40 minutes, so as to form a hard oxide layer with a thickness of 10 μm to 50 μm.

Optionally, the anti-sticking hole is a circle and/or a polygon, and when the anti-sticking hole is a circle, an aperture thereof is a diameter of the circle; and when the anti-sticking hole is a polygon, an outer diameter thereof is a diameter of a circumscribed circle of the polygon.

Optionally, the anti-sticking hole has an aperture of 0.5 mm to 3 mm and a depth of 50 μm to 200 μm.

Optionally, the plate is made of aluminum, titanium or magnesium; or the plate is made of a composite material, and the surface of the plate that is punched or etched to form the anti-sticking holes is made of aluminum, magnesium or titanium.

Optionally, during sanding, the inner surface of the cookware body is firstly sanded by using an abrasive cloth with a mesh size of 80 to 180 meshes for coarse sanding, and then sanded by using an abrasive cloth with a mesh size of 400 to 2000 meshes for fine sanding.

By treatments such as sanding and polishing, the roughness of the inner surface of the cookware is improved, and the friction between food and the inner surface of the cookware body is reduced, so that a spatula can stir-fry a dish more smoothly.

These characteristics and advantages of the present disclosure will be disclosed in detail in the following specific embodiments and drawings. The exemplary embodiments or means of the present disclosure will be described in detail with reference to the drawings, but are not intended to limit the technical solutions of the present disclosure. In addition, the features, elements, and components appearing in the following description and drawings are plural, and marked with different symbols or numerals for the convenience of presentation, while each representing parts with the same or similar configurations or functions.

### BRIEF DESCRIPTION OF DRAWINGS

The present disclosure will be further described with reference to the drawings:

FIG. 1 illustrates a top view of a distribution of anti-sticking holes in an embodiment of the present disclosure;

FIG. 2 illustrates a cross-sectional view of a cookware body material in an embodiment of the present disclosure;

FIG. 3 illustrates an enlarged view of anti-sticking holes in an embodiment of the present disclosure;

FIG. 4 illustrates an image of anti-sticking holes in an embodiment of the present disclosure under a scanning electron microscope; and

FIG. 5 illustrates a flowchart of a manufacturing method of a non-coated non-stick cookware in an embodiment of the present disclosure.

1: anti-sticking hole, 2: plate, 3: hard oxide layer.

### DETAILED DESCRIPTION OF EMBODIMENTS

The technical solutions of the embodiments of the present disclosure will be explained and described below with reference to the drawings. The following embodiments are only a part, rather than all, of the embodiments of the present disclosure. All other embodiments derived by persons skilled in the art from the embodiments of the present disclosure without making inventive efforts shall fall within the scope of the present disclosure.

The reference to “an embodiment” or “an example” in the specification means that a specific feature, structure or characteristic described in conjunction with an embodiment may be included in at least one embodiment disclosed in this patent. The phrase “in an embodiment” variously occurring in the specification does not necessarily refer to the same embodiment.

### Embodiment 1

This embodiment provides a non-coated non-stick cookware including a cookware body. The cookware body is made of aluminum, titanium or magnesium, and may also be made of a composite material, such as aluminum steel, magnesium steel, or titanium aluminum steel, which is not limited here. When the cookware body is made of a composite material, an inner surface thereof should be made of aluminum, magnesium or titanium to facilitate the formation of anti-sticking holes.

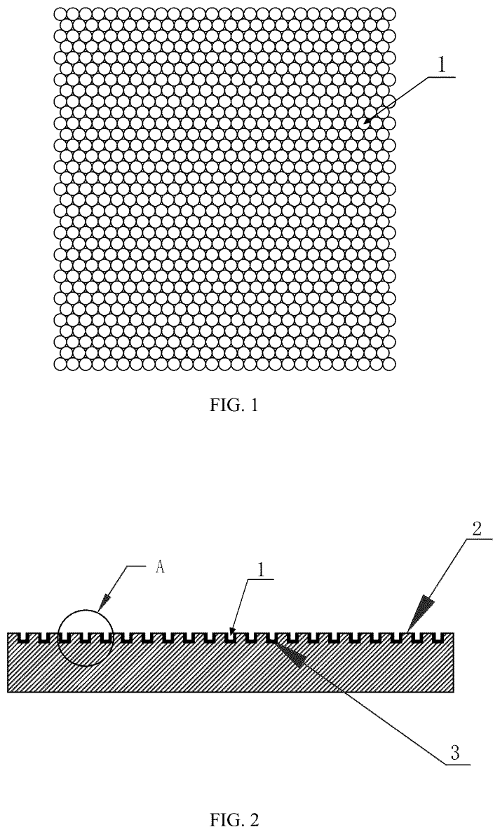

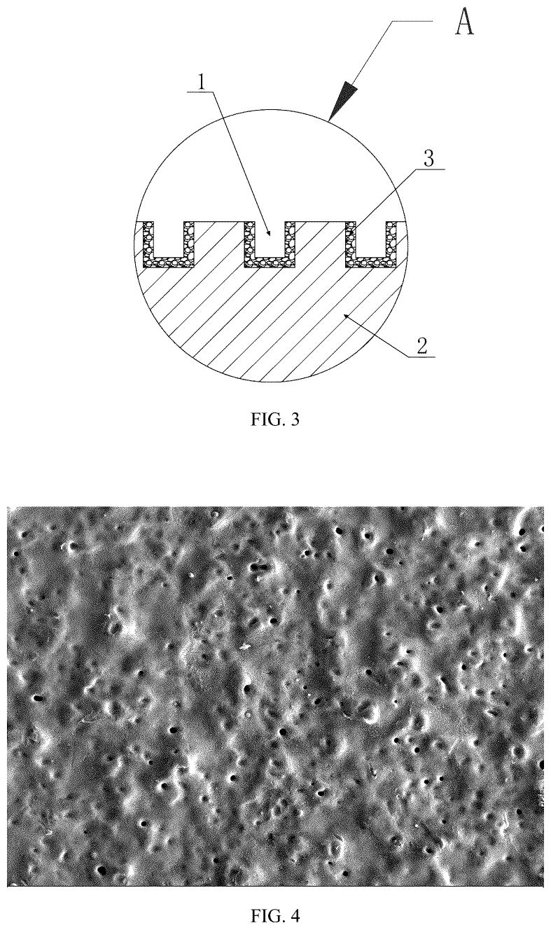

The non-stick cookware with honeycomb coating in the prior art has the characteristic that the honeycomb holes are large with an aperture more than 3 mm, so the bottom surfaces of the honeycomb holes are also coated with coating that has a large area of about 80% to 90% of the surface area of the base material. As a result, the contact area between the coating and food is also large, which leads to a large friction surface with food, such that the coating is easily worn and has a short service life. Therefore, this embodiment provides a technical solution that disposes anti-sticking holes on the inner surface of the cookware body. Based on the principle of calculus, the inner surface of the cookware body is equally divided into numerous micro-planes to form respective anti-sticking holes 1, as illustrated in FIGS. 1 and 2, with apertures perpendicular to a surface of a plate 1, thereby achieving the effects of high density and small diameter. As illustrated in FIG. 3, an inner wall and/or a bottom wall of the anti-sticking hole 1 is provided with a hard oxide layer 3, and the hard oxide layer 3 has a thickness of 10 μm to 50 μm and is attached to the surface in the anti-sticking hole 1 of the plate 2. As illustrated in FIG. 4, the hard oxide layer 3 has micro-pores, and the edges of some or all micro-pores are mastoid-shaped. These mastoid-shaped structures on the surface of the hard oxide layer achieve an effect like fluffs on the surface of a lotus leaf, so as to obtain a non-stick effect similar to the hydrophobic principle of the lotus leaf. In this embodiment, if the plate forming the cookware body is made of titanium, a hard oxide layer of titanium dioxide with Vickers hardness not lower than HV600 will be generated on the surface of the plate on which the micro-arc oxidation has been carried out; and if the plate forming the cookware body is made of aluminum alloy, a hard oxide layer of aluminum oxide with Vickers hardness not lower than HV1000 will be generated on the surface of the plate on which the micro-arc oxidation has been carried out. The Vickers hardness of the hard oxide layer generated from other materials should not be lower than HV500. The generated hard oxide layer with high hardness makes the inner surface of the cookware body resistant to a metal spatula. These nano-sized pores will absorb air and grease during actual use, and generate hot air and oil mist during heating, while holding up food. By means of the fluff-like effect achieved by the mastoid-shaped structures, the friction between food and the inner surface of the cookware body is reduced, thus achieving the non-stick effect by physical means without chemical coating, so that consumers can cook food more healthily. In addition, with the characteristics of dry-burning resistance and high-temperature resistance, the oxide in the anti-sticking hole can withstand a high temperature of 1000° C. without reduction in performance, so there is no need to worry about dry burning of the cookware.

In this embodiment, the anti-sticking hole 1 has an aperture of 0.5 mm to 3 mm and a depth of 50 μm to 200 μm, which not only ensures that the hard oxide layer can achieve the fluff-like effect after being formed in the anti-sticking hole, but also reduces the contact area between food and the base material of the inner surface of the cookware body, and reduces the friction between food and the surface of the cookware. In this embodiment, the anti-sticking hole 1 is a circle, and the aperture of the anti-sticking hole 1 is a diameter of the circle. In other embodiments, the anti-sticking hole 1 may also be a polygon, such as a quadrangle, a rhombus, a hexagon, an octagon, etc., or a combination of a circle and a polygon, or a combination of different polygons, which is not limited here. When the anti-sticking hole 1 is a polygon, an outer diameter of the anti-sticking hole 1 is a diameter of a circumscribed circle of the polygon. In this embodiment, the anti-sticking hole 1 is formed by etching the plate 2 that constitutes the cookware body. The etching process is a low-cost process at present, but in other embodiments, the anti-sticking hole 1 may also be formed by punching, which is not limited here.

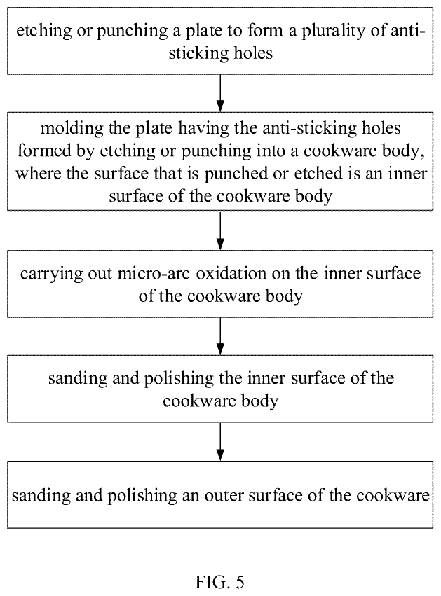

Meanwhile, this embodiment further provides a manufacturing method of a non-coated non-stick cookware, as illustrated in FIG. 5, which includes the following steps:
S1: etching or punching a plate to form a plurality of anti-sticking holes on a surface of the plate. The plate is an aluminum plate, a titanium plate or a magnesium plate, and may be a plate made of a composite material, such as aluminum steel, magnesium steel, titanium aluminum steel, which is not limited here. When the plate is made of a composite material, the surface that is punched or etched to form the anti-sticking holes should be made of aluminum, magnesium or titanium to facilitate forming the anti-sticking holes.

In this step, the anti-sticking hole formed by etching or punching has an aperture of 0.5 mm to 3 mm and a depth of 50 μm to 200 μm perpendicular to the surface of the plate. In this embodiment, the anti-sticking hole is a circle, and the aperture of the anti-sticking hole is a diameter of the circle. In other embodiments, the anti-sticking hole may also be a polygon, such as a quadrangle, a rhombus, a hexagon, an octagon, etc., or a combination of a circle and a polygon, or a combination of different polygons, which is not limited here. When the anti-sticking hole is a polygon, an outer diameter of the anti-sticking hole is a diameter of a circumscribed circle of the polygon.
S2: molding the plate having the anti-sticking holes formed by etching or punching into a cookware body, where the surface that is punched or etched is an inner surface of the cookware body, thereby reducing the contact area between food and a base material of the inner surface of the cookware body, and reducing the friction between food and the surface of the cookware.
S3: carrying out micro-arc oxidation on the inner surface of the cookware body, with a current per square decimeter of 1 A to 3 A, a voltage per square decimeter of 300 V to 550 V, an oxidation time of 25 to 40 minutes, and a duty ratio of 3% to 10%, so as to form a hard oxide layer with a thickness of 10 μm to 50 μm. The micro-arc oxidation makes the surface of the plate form a porous super-hard metal oxide with a nano-crystal structure. The hard oxide layer has micro-pores, and the edges of some or all micro-pores are of mastoid-shaped. These nano-sized pores will absorb air and grease during actual use, and generate hot air and oil mist during heating, while holding up food. By means of the fluff-like effect achieved by the mastoid-shaped structures, the friction between food and the inner surface of the cookware body is reduced, thus achieving the non-stick effect by physical means without chemical coating, so that consumers can cook food more healthily. If the plate forming the cookware body is made of titanium, a hard oxide layer of titanium dioxide with Vickers hardness not lower than HV600 will be generated on the surface of the plate on which the micro-arc oxidation has been carried out; and if the plate forming the cookware body is made of aluminum alloy, a hard oxide layer of aluminum oxide with Vickers hardness not lower than HV1000 will be generated on the surface of the plate on which the micro-arc oxidation has been carried out. The Vickers hardness of the hard oxide layer generated from other materials should not be lower than HV500. The generated hard oxide layer with high hardness makes the inner surface of the cookware body resistant to a metal spatula.
S4: sanding and polishing the inner surface of the cookware body, to remove the hard oxide layer and improve the roughness of the inner surface of the cookware body, that is, improving the smoothness of the operation of a steel spatula: firstly, selecting an abrasive cloth with a mesh size of 80 to 180 meshes for coarse sanding, then selecting an abrasive cloth with a mesh size of 400 to 2000 meshes for fine sanding, and finally fine polishing by using a cotton wheel or a wool wheel, so that the inner surface of cookware body has consistent mirror finish. In this step, the hard oxide layer in the anti-sticking hole is retained because it is lower than the surface of the plate, so that the inner surface of the cookware body is actually constituted by a plurality of hardened hole points and a plate layer. After polishing, the roughness reaches Ra 0.6 to 1, which reduces the friction between food and the inner surface of the cookware body, so that the operation of the spatula is smoother during cooking.

1S5: sanding and polishing an outer surface of the cookware body.

The cookware, which is manufactured by the manufacturing method of a non-coated non-stick cookware provided by this embodiment, may have one or two lifting lugs, or may be mounted with a handle, which is not limited here.

The manufacturing method of a non-stick cookware provided by this embodiment eliminates the use of chemicals such as the existing non-stick paint, so that consumers can cook food more healthily. Meanwhile, since the oxide in the anti-sticking hole has the characteristics of dry-burning resistance and high-temperature resistance, it can withstand a high temperature of 1000° C. without reduction in performance, so there is no need to worry about dry burning of the cookware.

It should be appreciated by those skilled in the art that the step S1 in the manufacturing method of the non-stick cookware provided by this embodiment may be completed by either the manufacturer of the cookware and the manufacturer of the plate.

Those described above are only the specific embodiments of the present disclosure, and the protection scope of the present disclosure is not limited thereto. Those skilled in the art should understand that the present disclosure includes but is not limited to the contents illustrated in the drawings and described in the above specific embodiments. Any modification that does not deviate from the functional and structural principles of the present disclosure will be included in the scope of the claims.

1. A non-coated non-stick cookware, comprising a cookware body, wherein a plurality of anti-sticking holes are distributed on an inner surface of the cookware body, an inner wall and/or a bottom wall of the anti-sticking hole is provided with a micro-arc oxide layer which has a plurality of nano-scale micropores, and edges of some or all of the micropores are of mastoid-shaped.

2. The non-coated non-stick cookware according to claim 1, wherein the micro-arc oxide layer has a thickness of 10 μm to 50 μm.

3. The non-coated non-stick cookware according to claim 1, wherein the anti-sticking hole is a circle and/or a polygon, and when the anti-sticking hole is a circle, an aperture thereof is a diameter of the circle; and when the anti-sticking hole is a polygon, an outer diameter thereof is a diameter of a circumscribed circle of the polygon.

4. The non-coated non-stick cookware according to claim 1, wherein the anti-sticking hole has an aperture of 0.5 mm to 3 mm and a depth of 50 μm to 200 μm.

5. The non-coated non-stick cookware according to claim 1, wherein the anti-sticking hole is formed by etching or punching a plate which constitutes the cookware body.

6. The non-coated non-stick cookware according to claim 1, wherein the cookware body is made of aluminum, titanium or magnesium; or
the cookware body is made of a composite material, and the inner surface of the cookware body is made of aluminum, magnesium or titanium.

7. A manufacturing method of a non-coated non-stick cookware, comprising the steps of:
etching or punching a plate to form anti-sticking holes on a surface of the plate, and molding the plate having the anti-sticking holes formed by etching or punching into a cookware body, wherein the surface that is punched or etched is an inner surface of the cookware body;
carrying out micro-arc oxidation on the inner surface of the cookware body, to form a micro-arc oxide layer with nano-scale micropores, wherein edges of some or all of the micropores are of mastoid-shaped;
sanding and polishing the inner surface of the cookware body to remove the micro-arc oxide layer on the inner surface; and
sanding and polishing an outer surface of the cookware body.

8. The manufacturing method of the non-coated non-stick cookware according to claim 7, wherein the micro-arc oxidation is carried out with a current per square decimeter of 1 A to 3 A, a voltage per square decimeter of 300 V to 550 V, a duty ratio of 3% to 10%, and an oxidation time of 25 to 40 minutes, so as to form a micro-arc oxide layer with a thickness of 10 μm to 50 μm.

9. The manufacturing method of the non-coated non-stick cookware according to claim 7, wherein the anti-sticking hole is a circle and/or a polygon, and when the anti-sticking hole is a circle, an aperture thereof is a diameter of the circle; and when the anti-sticking hole is a polygon, an outer diameter thereof is a diameter of a circumscribed circle of the polygon.

10. The manufacturing method of the non-coated non-stick cookware according to claim 7, wherein the anti-sticking hole has an aperture of 0.5 mm to 3 mm and a depth of 50 μm to 200 μm.

11. The manufacturing method of the non-coated non-stick cookware according to claim 7, wherein the plate is made of aluminum, titanium or magnesium; or
the plate is made of a composite material, and the surface of the plate that is punched or etched to form the anti-sticking holes is made of aluminum, magnesium or titanium.

12. The method for manufacturing the non-coated non-stick cookware according to claim 7, wherein during sanding, the inner surface of the cookware body is firstly sanded by using an abrasive cloth with a mesh size of 80 to 180 meshes for coarse sanding, and then sanded by using an abrasive cloth with a mesh size of 400 to 2000 meshes for fine sanding.

13. The non-coated non-stick cookware according to claim 2, wherein the anti-sticking hole is a circle and/or a polygon, and when the anti-sticking hole is a circle, an aperture thereof is a diameter of the circle; and
when the anti-sticking hole is a polygon, an outer diameter thereof is a diameter of a circumscribed circle of the polygon.

14. The non-coated non-stick cookware according to claim 2, wherein the anti-sticking hole has an aperture of 0.5 mm to 3 mm and a depth of 50 μm to 200 μm; or
the anti-sticking hole is formed by etching or punching a plate which constitutes the cookware body.

15. The non-coated non-stick cookware according to claim 2, wherein the cookware body is made of aluminum, titanium or magnesium; or
the cookware body is made of a composite material, and the inner surface of the cookware body is made of aluminum, magnesium or titanium.

16. The non-coated non-stick cookware according to claim 1, wherein the micropores are provided on a surface and in an interior of the micro-arc oxide layer, and the edges of some or all of the micropores on the surface of the micro-arc oxide layer are of mastoid-shaped.

17. The manufacturing method of the non-coated non-stick cookware according to claim 8, wherein the anti-sticking hole is a circle and/or a polygon, and when the anti-sticking hole is a circle, an aperture thereof is a diameter of the circle; and
when the anti-sticking hole is a polygon, an outer diameter thereof is a diameter of a circumscribed circle of the polygon.

18. The manufacturing method of the non-coated non-stick cookware according to claim 8, wherein the plate is made of aluminum, titanium or magnesium; or
the plate is made of a composite material, and the surface of the plate that is punched or etched to form the anti-sticking holes is made of aluminum, magnesium or titanium.

19. The method for manufacturing the non-coated non-stick cookware according to claim 8, wherein during sanding, the inner surface of the cookware body is firstly sanded by using an abrasive cloth with a mesh size of 80 to 180 meshes for coarse sanding, and then sanded by using an abrasive cloth with a mesh size of 400 to 2000 meshes for fine sanding.

20. The method for manufacturing the non-coated non-stick cookware according to claim 7, wherein the micropores are provided on a surface and in an interior of the micro-arc oxide layer, and the edges of some or all of the micropores on the surface of the micro-arc oxide layer are of mastoid-shaped.
